(19) United States
(12) Patent Application Publication
(10) Pub. No.: US 2008/0244956 A1
(43) Pub. Date: Oct. 9, 2008

(54) FISHING ROD INCLUDING A HOOK RECEPTACLE

(75) Inventors: Robert GANT, Ladera Ranch, CA (US); David PFEIFFER, San Juan Capistrano, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: SHIMANO AMERICAN CORPORATION, Irvine, CA (US)

(21) Appl. No.: 11/696,096

(22) Filed: Apr. 3, 2007

(51) Int. Cl. A01K 87/00; A01K 97/06

(52) U.S. Cl. 43/25.2; 43/23

(57) ABSTRACT

A fishing rod that includes a rod portion having an outer circumference, at least one line guide portion, a reel secured to the rod portion, a line that extends through the line guide portion and has a hook secured to the end thereof, a handle portion that extends at least partially around the outer diameter of the rod portion, and a hook receptacle defined in the handle portion. The hook can be removably secured in the hook receptacle.

### FIELD OF THE INVENTION

The present invention concerns fishing rods, and more particularly to a fishing rod having a receptacle for storing a hook when the rod is not in use.

### BACKGROUND OF THE INVENTION

Many approaches have been used to effect the secure protection of fishing lures or hooks from inadvertent snagging during storage or transport to the fishing site.

Many fisherman attach a fishing lure or hook to the fishing line and then attach the fishing lure or hook to the fishing rod directly either to one of the line guides (which can cause the line to abrade) or to some other attachment point on the fishing rod. For example, some rods include a hook keeper placed on the fishing rod above the foregrip. This type of prior art keeper, which typically comprises a bent piece of wire that is attached to the rod above the foregrip, often gets in the way while fishing and is prone to bending or breaking off of the rod because it is exposed.

In other situations, users place the hook into the cork of the handle, which can damage it, or on the cross bar of the reel, which can scratch the cross bar.

Accordingly, a need exists for a fishing rod that overcomes the disadvantages mentioned above.

### SUMMARY OF THE INVENTION

In accordance with an aspect of the present invention, there is provided a fishing rod that includes a rod portion having an outer circumference, a handle portion that extends at least partially around the outer diameter of the rod portion, and a hook receptacle defined in the handle portion. In a preferred embodiment, the hook receptacle comprises an opening that extends into the rear surface of the handle portion in a direction that is substantially parallel to the axis of the rod portion.

In accordance with another aspect of the present invention, there is provided a fishing rod that includes a rod portion having an outer circumference, at least one line guide portion, a reel secured to the rod portion, a line that extends through the line guide portion and has a hook secured to the end thereof, a handle portion that extends at least partially around the outer diameter of the rod portion, and a hook receptacle defined in the handle portion. The hook can be removably secured in the hook receptacle.

The novel features which are believed to be characteristic of the invention, together with further objectives and advantages thereof, will be better understood from the following description considered in connection with the accompanying drawings in which a presently preferred embodiment and an alternate embodiment of the invention are illustrated by way of example. It is to be expressly understood, however, that the drawings are for the purpose of illustration and description only, and are not intended as a definition of the limits of the invention.

### BRIEF DESCRIPTION OF THE DRAWINGS

FIG. 1 is a perspective view of a fishing rod including a hook receptacle in the handle portion thereof in accordance with a first preferred embodiment of the invention;

FIG. 2 is a side elevational view of the fishing rod of FIG. 1;

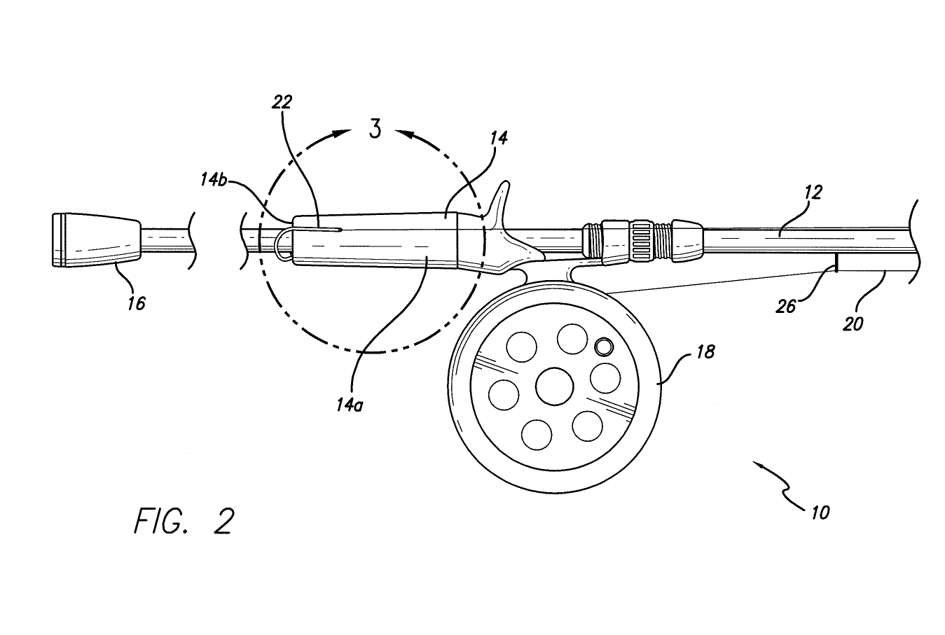

FIG. 3 is a cross-sectional view of the handle portion of the fishing rod of FIG. 1 showing the hook in the hook receptacle; and

FIG. 4 is a perspective view of a fishing rod including a hook receptacle in the reel thereof in accordance with a first preferred embodiment of the invention.

### DETAILED DESCRIPTION OF THE INVENTION

As shown in the drawings, for purposes of illustration, a preferred embodiment of the invention is a receptacle that is built into a fishing rod or reel component, such as the handle, for storing a hook attached to the fishing line.

For exemplary purposes only, described hereinbelow is a preferred embodiment wherein the receptacle is used with a single hook to be baited. However, this is not a limitation on the present invention. It will be understood that the receptacle can be used with other hooks, such as a lure that includes a plurality of hooks.

It will be appreciated that terms such as “front,” “back,” “top,” “bottom,” “side,” and “below” used herein are merely for ease of description and refer to the orientation of the components as shown in the figures. It should be understood that any orientation of the rod or reel, and the components thereof described herein is within the scope of the present invention.

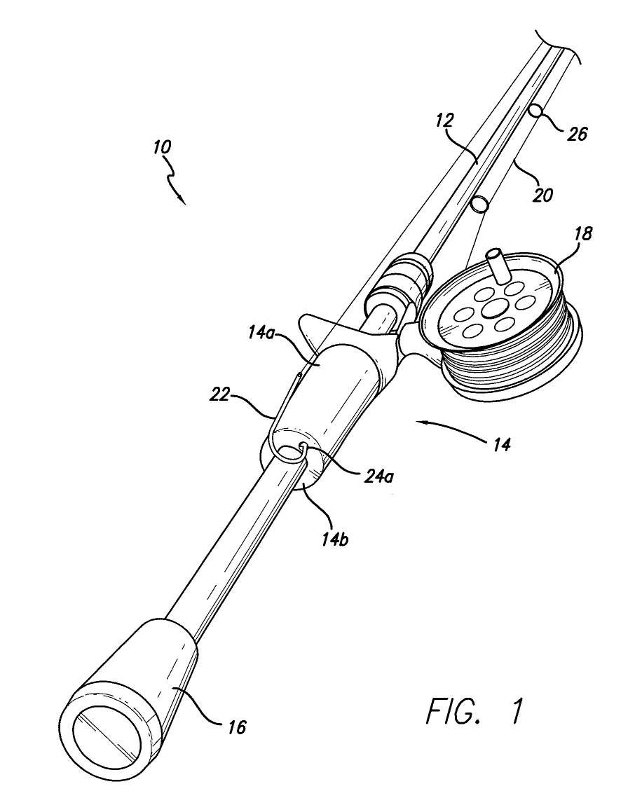

As shown in FIG. 1, a preferred embodiment of the fishing rod and reel combination 10 of the present invention includes a rod portion 12, a first handle portion 14, a second handle portion 16, a reel 18, a line 20, a hook 22 and a hook receptacle 24. It will be understood that the type of rod or reel is not a limitation on the present invention.

The rod portion 12 includes a plurality of line guide portions 26 thereon for guiding the line 20 down the length of the rod portion 12. However, it will be understood that the type of line guide portion is not a limitation on the present invention. For example, some rods may include a line that runs through the interior of the rod (and that includes line guide portions therein).

As shown in the figures, the first handle portion 14 extends circumferentially around the outer circumference of the rod portion 12. The first handle portion 14 can be made of any material. However in a preferred embodiment, the first handle portion 14 is made of cork, EVA foam or the like. However, it will be understood that the material is not a limitation on the present invention.

The first handle portion 14 is preferably tubular in shape, thereby allowing the rod portion 12 to extend through an axially extending central opening. This shape provides an outer circumferential surface 14a and a rear surface 14b. In another embodiment, the first handle portion 14 may not extend around the entire outer circumference of the handle portion 14.

In a preferred embodiment, the hook receptacle 24 comprises an opening that extends into the first handle portion 14 in a direction that is substantially parallel to the axis of the rod portion 12. Preferably, the hook receptacle is tubular or cylindrical in shape and is embedded in the first handle portion, such that an opening 24a at a first end thereof is substantially flush with the rear surface 14b. However, it will be understood that the hook receptacle does not have to be tubular or cylindrical in shape. Any shape that allows a hook to be inserted therein is within the scope of the present invention.

In the embodiment shown in the figures, the hook receptacle 24 has an open end 24a and a closed end 24b. However, in another embodiment, both ends are open. In a preferred embodiment, the hook receptacle 24 is made of a metal, such as aluminum or stainless steel, however, it can also be made of another rigid material, such as a plastic.

It will be understood that the hook receptacle 24 may also be an opening defined in the first handle portion 14 (or other component) as opposed to being a tube that is embedded therein. For example, the first handle portion 14 may be made of a hard plastic and include the hook receptacle 24 molded therein.

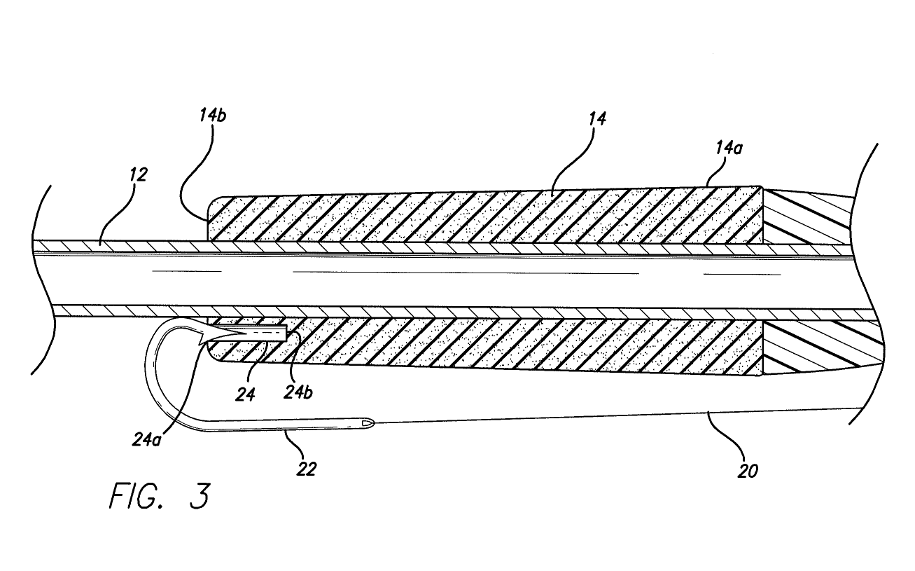

To use the present invention, before transporting or storing the fishing rod and reel 10, a user takes the hook 22 that is attached to the end of the line 20 and inserts the pointed end into the hook receptacle 24, as best shown in FIG. 3. In some instances, the user may wind the reel to place tension in the line 20 to help secure the hook 22 in the hook receptacle 24.

In an alternative embodiment of the invention the hook receptacle may be defined in the outer circumferential surface 14a of the first handle portion 14. In this embodiment, an opening is defined in the outer circumferential surface 14a, but at least a portion of the opening runs parallel to the axis of the rod portion 12. Therefore, the opening is still flush with the outer circumferential surface 14a, and nothing protrudes from the first handle portion 14, thereby preventing any protruding parts from getting in the way of a user. This embodiment may comprise a tube embedded, molded or defined in the first handle portion that includes an axis parallel to the rod portion 12, but that has it's rearward facing end open to the exterior of the outer circumferential surface 14a of the first handle portion 14. Such a hook receptacle could also be included on the second handle portion 26 or the rod portion 12.

In another embodiment, the first handle portion 14 (or other component) may be made of a softer material, such as cork or EVA foam, and may have a tubular shaped opening defined therein, similar to that shown in FIG. 3. However, instead of embedding a long tube therein, the hook receptacle may include a rigid ring disposed therein.

It will be further understood that the hook receptacle 24 does not have to be included on the first handle portion 14, but can be included in any component of the fishing rod or reel. In another embodiment, the hook receptacle 24 can be embedded, molded or defined in the second handle portion 16. In another embodiment, the first and second handle portions can be connected to define a single aftgrip or aft handle portion that includes the hook receptacle. In another embodiment, the rod can include a foregrip that is located ahead of the reel seat and that includes a hook receptacle. In yet another embodiment, the rod can include a plurality of hook receptacles either on the same handle portions or on different handle portions. The placement nor size of the handle portion is not a limitation on the present invention.

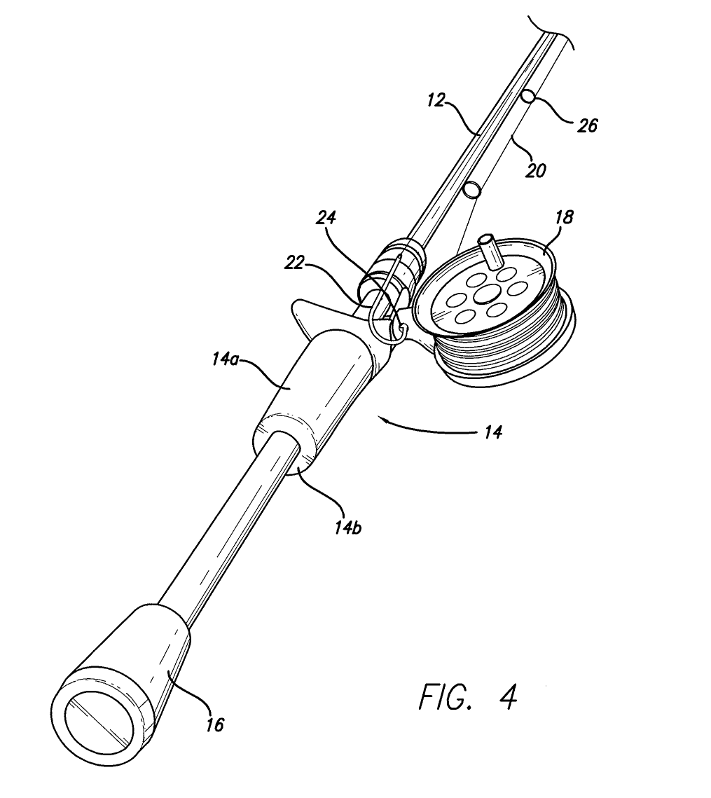

As shown in FIG. 4, in another embodiment, the hook receptacle 24 can be embedded, molded or defined in the reel 18. Here, the receptacle 24 is located in the reel foot. Other reels include a cross bar that spans the portion of the reel where the line is spooled. It is within the scope of the present invention to include a hook receptacle in the cross bar. In this embodiment, the receptacle may be an opening defined in the cross bar into which the hook is inserted.

The embodiments described above are exemplary embodiments of a hook receiver and its placement on a fishing pole. The invention is readily applicable to areas on the fishing pole other than the handle or reel. Those skilled in the art may now make numerous uses of, and departures from, the above-described embodiments without departing from the inventive concepts disclosed herein. Accordingly, the present invention is to be defined solely by the scope of the following claims.

What is claimed is:

1. A fishing rod comprising:
a rod portion having an outer circumference,
a handle portion that extends at least partially around the outer diameter of the rod portion, and
a hook receptacle defined in the handle portion.

2. The fishing rod of claim 1, wherein the hook receptacle comprises an opening that extends into the handle portion in a direction that is substantially parallel to the axis of the rod portion.

3. The fishing rod of claim 2 wherein the handle portion includes an outer circumferential surface and a rear surface, and wherein the hook receptacle is defined in the rear surface.

4. The fishing rod of claim 3 wherein the hook receptacle comprises a tube that is embedded in the rear surface of the handle portion.

5. The fishing rod of claim 4 wherein the hook receptacle is made of a rigid material.

6. The fishing rod of claim 5 wherein the hook receptacle is made of metal.

7. A fishing rod and reel comprising:
a rod portion having an outer circumference,
at least one line guide portion,
a reel secured to the rod portion, wherein the reel includes a line that extends through the line guide portion and has a hook secured to the end thereof,
a handle portion that extends at least partially around the outer diameter of the rod portion, and
a hook receptacle defined in the handle portion, wherein
the hook is removably secured in the hook receptacle.

8. The fishing rod and reel of claim 7, wherein the hook receptacle comprises an opening that extends into the handle portion in a direction that is substantially parallel to the axis of the rod portion.

9. The fishing rod and reel of claim 8 wherein the handle portion includes an outer circumferential surface and a rear surface, and wherein the hook receptacle is defined in the rear surface.

10. The fishing rod and reel of claim 9 wherein the hook receptacle comprises a tube that is embedded in the rear surface of the handle portion.

11. The fishing rod and reel of claim 10 wherein the hook receptacle is made of a rigid material.

12. The fishing rod and reel of claim 11 wherein the hook receptacle is made of metal.
